(19) United States
(12) Patent Application Publication
(10) Pub. No.: US 2024/0403803 A1
(43) Pub. Date: Dec. 5, 2024

(54) DELIVERY SUPPORT DEVICE

(71) Applicant: TOYOTA JIDOSHA KABUSHIKI KAISHA, Toyota-shi (JP)

(72) Inventors: Yohei NAKANISHI, Nagoya-shi (JP); Toshiharu FUKUMURA, Nagakute-shi (JP); Adrian NICOL, Nagoya-shi (JP); Ryuichi DANNO, Kasugai-shi (JP); Toshinorl KIMURA, Ichinomiya-shi (JP); Yoshiaki ABE, Kofu-shi (JP)

(73) Assignee: TOYOTA JIDOSHA KABUSHIKI KAISHA, Toyota-shi (JP)

(21) Appl. No.: 18/675,983

(22) Filed: May 28, 2024

(30) Foreign Application Priority Data
Jun. 2, 2023 (JP) 2023-091737

(51) Int. Cl. G06Q 10/083

(52) U.S. Cl. CPC G06Q 10/083

(57) ABSTRACT

The delivery support device is a device that notifies a customer of a magnitude of an environmental load caused by delivery of a package using a shipping vehicle. The control device of the delivery support device performs, when the redelivery of the package is required, calculation of the magnitude of the environmental load associated with the redelivery and notification of the magnitude of the environmental load associated with the redelivery to the customer who needs the redelivery . . .

### CROSS-REFERENCE TO RELATED APPLICATION

This application claims priority to Japanese Patent Application No. 2023-091737 filed on Jun. 2, 2023, incorporated herein by reference in its entirety.

### BACKGROUND

### 1. Technical Field

The disclosure relates to a delivery support device.

### 2. Description of Related Art

Japanese Unexamined Patent Application Publication No. 2012-83882 (JP 2012-83882 A) discloses a shipping plan creating device that calculates a prediction value of a carbon dioxide emission amount of a shipping vehicle, when a package is delivered to a customer at a delivery destination, in accordance with a predetermined shipping plan. This device modifies the shipping plan when the prediction value that is calculated exceeds an actual performance value of carbon dioxide emission amount of the shipping vehicle during delivery according to the shipping plan in the past.

### SUMMARY

When the customer at the delivery destination is absent when the shipping vehicle arrives, the delivery of the package to the customer cannot be completed, and accordingly redelivery of the package is necessary. When the package is redelivered, there is a concern that a psychological burden on the deliverer will increase, an environmental load will increase due to the delivery of the package using the shipping vehicle, and so forth.

A delivery support device for solving the above problem is a device that notifies a customer that receives a delivery service of a package using a shipping vehicle, regarding a magnitude of environmental load associated with delivery of the package using the shipping vehicle.

The delivery support device executes calculating a magnitude of environmental load associated with redelivery of the package, when redelivery becomes necessary, and notifying the customer needing redelivery regarding the magnitude of environmental load associated with the redelivery.

The above-described delivery support device is advantageous in that customers can be imparted with an awareness to maximally avert redelivery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating a delivery support device according to an embodiment and a shipping vehicle and a portable terminal capable of communicating with the delivery support device;

FIG. 2 is a schematic diagram illustrating an example of a delivery schedule of the shipping vehicle of FIG. 1;

FIG. 3 is a chart showing whether delivery of a package to a customer has been completed at a plurality of delivery destinations included in the delivery schedule of FIG. 2; and

FIG. 4 is a sequence diagram illustrating a flow of a process for notifying a customer of a magnitude of an environmental load caused by delivery of a package using a shipping vehicle.

### DETAILED DESCRIPTION OF EMBODIMENTS

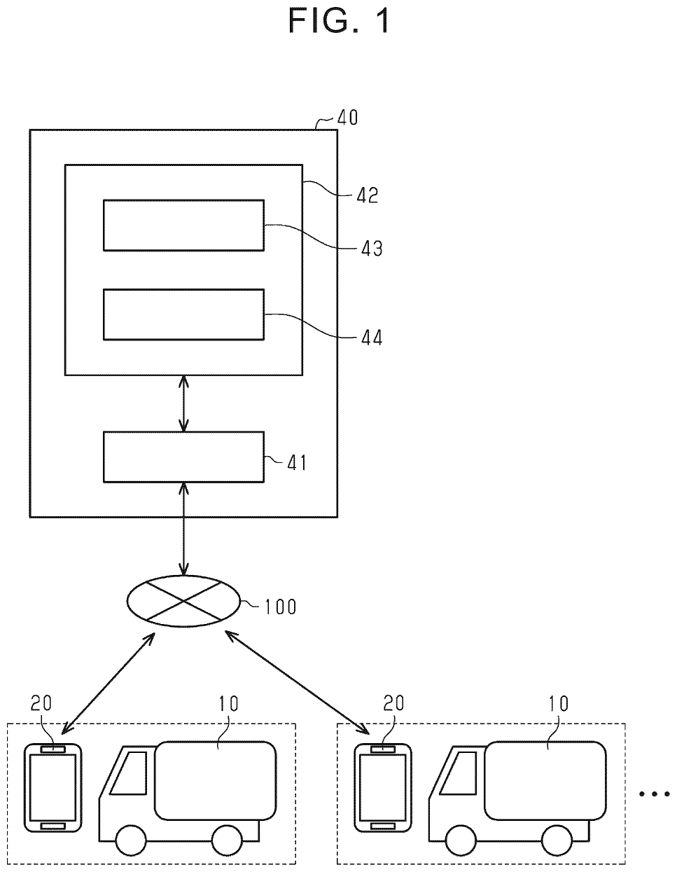

Hereinafter, an embodiment of a delivery support device will be described with reference to FIG. 1 to FIG. 4. FIG. 1 illustrates a delivery support device 40 and a plurality of shipping vehicles 10. Here, the “shipping vehicle 10” is a vehicle managed by the delivery support device 40. The “delivery destination” is a place where the package is delivered by the shipping vehicle 10.

### Shipping Vehicles

The plurality of shipping vehicles 10 respectively deliver the packages to the recipients of the packages at the plurality of delivery destination DL according to a preset shipping schedule SC.

The shipping vehicle 10 is ridden by a deliverer who delivers the package to the recipient of the delivery destination DL. The deliverer owns the mobile terminal 20. Examples of the mobile terminal 20 include a smartphone and a tablet terminal. The mobile terminal 20 is configured to be able to communicate with the delivery support device 40 via the communication network 100.

### Delivery Support Device

The delivery support device 40 includes a communication device 41 and a control device 42. The communication device 41 is an interface of the delivery support device 40 for transmitting and receiving information to and from an external communication device via the communication network 100. For example, the communication device 41 outputs information received via the communication network 100 to the control device 42. Further, for example, the communication device 41 transmits the information output from the control device 42 to the mobile terminal 20 of the deliverer via the communication network 100.

An example of the control device 42 is an electronic control device. The control device 42 includes a CPU 43 and a memory 44. The memory 44 stores a control program executed by CPU 43. When CPU 43 executes the control program of the memory 44, the control device 42 executes a series of processes for notifying the customer who receives the delivery service of the package using the shipping vehicle 10 of the magnitude of the environmental load caused by the delivery of the package using the shipping vehicle 10. The specific contents of this series of processing will be described later.

In the present embodiment, the control device 42 calculates the emission amount of carbon dioxide in the shipping vehicle 10 accompanying the travel of the shipping vehicle 10 as the magnitude of the environmental load.

### Series of Processes to Notify Customers of the Magnitude of the Environmental Load

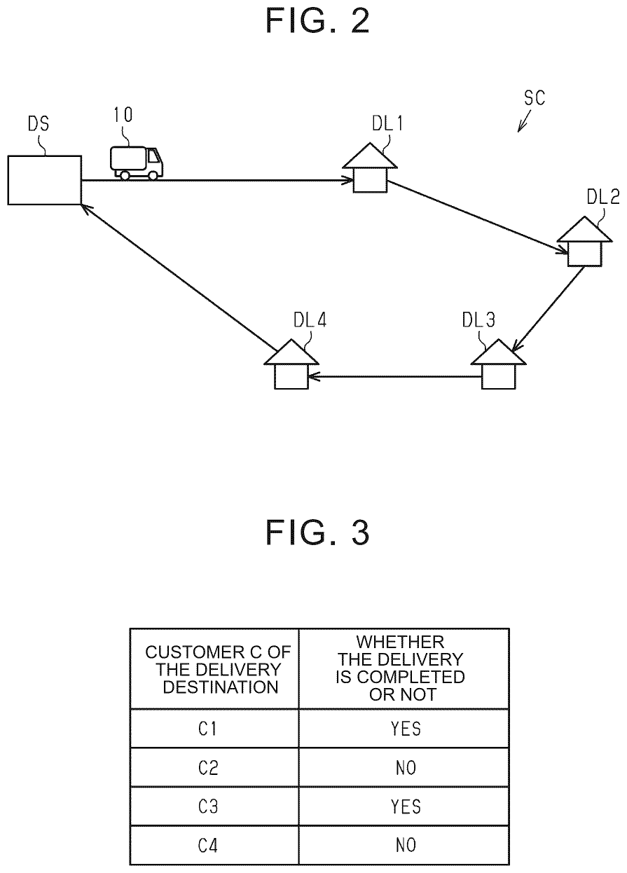

With reference to FIGS. 2 to 4, a series of processes for notifying the customer of the magnitude of the environmental load will be described.

Before describing the series of processes, an exemplary shipping schedule SC of the shipping vehicle 10 will be described. An exemplary shipping schedule SC shown in FIG. 2 is a schedule for delivering a package to four customers C. Specifically, according to the shipping schedule SC, when the shipping vehicle 10 leaves the delivery center DS, it runs in the order of delivery destination DL1, delivery destination DL2, delivery destination DL3, and delivery destination DL4. The recipient of the package at the delivery destination DL1 is the customer C1. The recipient of the package at the delivery destination DL2 is the customer C2. The recipient of the package at the delivery destination DL3 is the customer C3. The recipient of the package at the delivery destination DL4 is the customer C4.

In the embodiment illustrated in FIG. 3, it is assumed that, among the four customers C1, C2, C3 and C4, the shipping of the package is completed for the customer C1 and the customer C3. On the other hand, regarding the customer C2 and the customer C4, it is assumed that the shipping of the package has not been completed. That is, the customer C2 and the customer C4 need redelivery of the package. In other words, in the exemplary embodiments illustrated in FIGS. 2 and 3, the customer C1 and the customer C3 are customers that do not need to be redelivered, while the customer C2 and the customer C4 are customers that need to be redelivered.

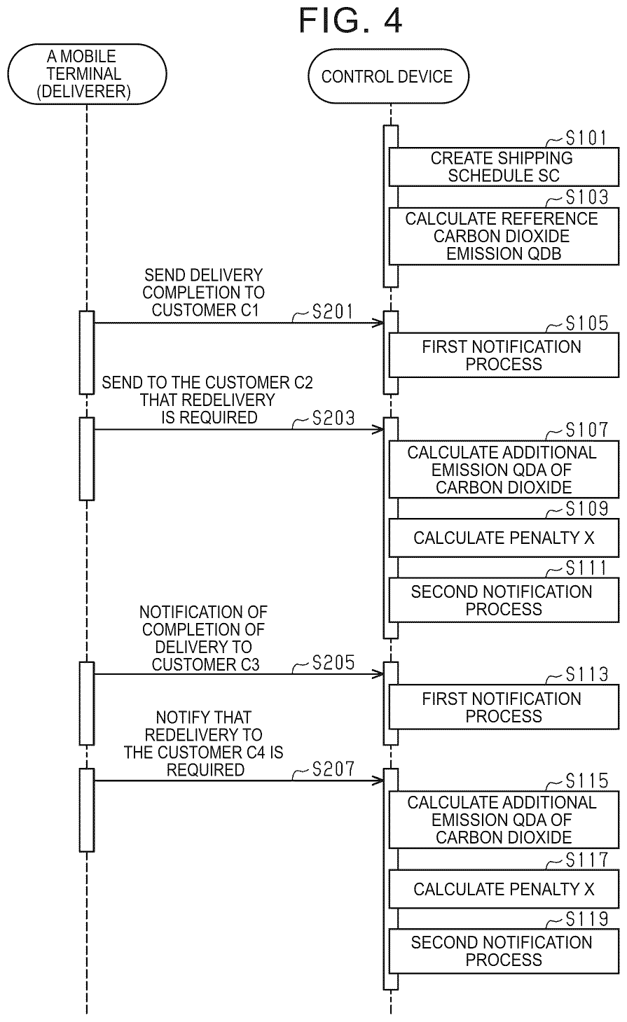

Referring to FIG. 4, a flow of a process when the shipping vehicle 10 delivers a package according to the shipping schedule SC will be described. In S101, the control device 42 of the delivery support device 40 creates a shipping schedule SC.

In the following S103, the control device 42 calculates a reference carbon dioxide emission QDB which is an emission amount of carbon dioxide of the shipping vehicle 10 when the shipping vehicle 10 delivers the package according to the shipping schedule SC. The control device 42 calculates the reference carbon dioxide emission QDB so that the traveling distance of the shipping vehicle 10 according to the shipping schedule SC becomes larger. For example, the control device 42 may calculate the reference carbon dioxide emission QDB by the improved ton-kilometer method. In this case, the control device 42 calculates the reference carbon dioxide emission QDB so that the product of the travel distance of the shipping vehicle 10 and the transportation weight of the shipping vehicle 10 according to the shipping schedule SC becomes larger. In the present embodiment, the reference carbon dioxide emission QDB corresponds to the “magnitude of the reference environmental load” which is the environmental load when the package is delivered in accordance with the shipping schedule SC.

The shipping vehicle 10 travels from the delivery center DS to the delivery destination DL1. In the exemplary embodiments illustrated in FIGS. 2 and 3, since the customer C1 of the delivery destination is at home or is permitted to be placed at home, the deliverer can deliver the package to the customer C1. Therefore, when the delivery of the package to the customer C1 is completed, the deliverer enters the mobile terminal 20 of the deliverer indicating that the delivery of the package to the customer C1 has been completed. Then, in S201, the mobile terminal 20 transmits, to the delivery support device 40, the fact that the delivery of the package to the customer C1 is completed via the communication network 100.

In the delivery support device 40, when the communication device 41 receives from the mobile terminal 20 that the delivery of the package to the customer C1 has been completed, the control device 42 executes S105 process. In S105, the control device 42 executes the first notification process. The first notification process is a process of notifying the customer C that does not require redelivery of the reference carbon dioxide emission QDB calculated by S103. Therefore, in S105, the control device 42 notifies the customer C1 of the reference carbon dioxide emission QDB by executing the first notification process. For example, the control device 42 causes the information terminal owned by the customer C1 to transmit information on the reference carbon dioxide emission QDB from the communication device 41. As a result, the delivery support device 40 can cause the customer C1 to recognize the magnitude of the environmental load caused by the delivery of the package.

When the delivery of the package to the customer C1 is completed, the shipping vehicle 10 moves from the delivery destination DL1 to the delivery destination DL2. In the embodiment shown in FIGS. 2 and 3, since the customer C2 of the delivery destination DL2 is absent and the placement is not permitted, the deliverer cannot deliver the package to the customer C2. Thus, the deliverer enters his or her mobile terminal 20 indicating that the package needs to be redelivered to the customer C2. Then, in S203, the mobile terminal 20 transmits, via the communication network 100, to the delivery support device 40 that redelivery to the customer C2 is required.

In the delivery support device 40, when the communication device 41 receives from the mobile terminal 20 that redelivery to the customer C2 is required, the control device 42 executes S107 process. In S107, the control device 42 calculates an additional emission QDA of carbon dioxide as an emission amount of carbon dioxide in the shipping vehicle 10 caused by redelivery to the customer C2. For example, the control device 42 calculates the additional emission QDA such that the longer the route from the delivery-center DS to the delivery-destination DL2, the larger the value. For example, as in the case of calculating the reference carbon dioxide emission QDB, the control device 42 may calculate the additional emission QDA by the improved ton-kilometer method. In the present embodiment, the additional emissions QDA corresponds to the magnitude of the environmental load associated with the redelivery.

In a subsequent S109, the control device 42 calculates a penalty X to the customer C2 for a redelivery. The control device 42 calculates a value corresponding to the additional emission QDA as a penalty X. An example of a penalty X is a fine. In this case, the control device 42 may calculate a fine such that the larger the additional emission QDA, the larger the amount of money.

In the following S111, the control device 42 executes the second notification process. The second notification process is a process of notifying the customers who wish redelivery of information indicated by the following (A1), (A2), and (A3). Therefore, in S111, the control device 42 executes the second notification process to notify the customer C2 of the following (A1), (A2), and (A3). For example, the control device 42 causes an information terminal owned by the customer C2 to transmit information indicated by the following (A1), (A2), and (A3) from the communication device 41. That is, the control device 42 notifies the customer C2 of the reference carbon dioxide emission QDB and the additional emission QDA associated with the redelivery to the customer C2 by distinguishing them from each other. Accordingly, the delivery support device 40 can cause the customer C2 to recognize the magnitude of the environmental load associated with the delivery of the package and the magnitude of the environmental load associated with the redelivery.

(A1) Standard carbon dioxide emissions QDB.

(A2) Additional emissions QDA.

(A3) Penalty X.

The shipping vehicle 10 goes from the delivery destination DL2 to the delivery destination DL3. In the exemplary embodiments illustrated in FIGS. 2 and 3, since the customer C3 of the delivery destination DL3 is at home or is permitted to be placed at home, the deliverer can deliver the package to the customer C3. Therefore, when the delivery of the package to the customer C3 is completed, the deliverer enters the mobile terminal 20 of the deliverer indicating that the delivery of the package to the customer C3 has been completed. Then, in S205, the mobile terminal 20 transmits, to the delivery support device 40, the fact that the delivery of the package to the customer C3 is completed via the communication network 100.

In the delivery support device 40, when the communication device 41 receives from the mobile terminal 20 that the delivery of the package to the customer C3 has been completed, the control device 42 executes S113 process. In S113, the control device 42 executes the first notification process in the same manner as S105.

When the delivery of the package to the customer C3 is completed, the shipping vehicle 10 moves from the delivery destination DL3 to the delivery destination DL4. In the embodiment shown in FIGS. 2 and 3, since the customer C4 of the delivery destination DL4 is absent and the placement is not permitted, the deliverer cannot deliver the package to the customer C4. Thus, the deliverer enters his or her mobile terminal 20 indicating that the package needs to be redelivered to the customer C4. Then, in S207, the mobile terminal 20 transmits, via the communication network 100, to the delivery support device 40 that redelivery to the customer C4 is required.

In the delivery support device 40, when the communication device 41 receives from the mobile terminal 20 that redelivery to the customer C4 is required, the control device 42 executes S115 process. In S115, the control device 42 calculates an additional emission QDA of carbon dioxide as an emission amount of carbon dioxide of the shipping vehicle 10 caused by redelivery to the customer C4 in the same manner as in the above S107. In the following S117, the control device 42 calculates a penalty X for the customer C4 for the redelivery, similar to the above S109. In the following S119, the control device 42 executes the second notification process in the same manner as in S111. Operation and Effect of the Present Embodiment
(1) In the delivery support device 40, the additional emission QDA is calculated as an additional amount of the emission amount of carbon dioxide accompanying the redelivery to the customer C who needs the redelivery. This additional emissions QDA is then notified to Customer C who needs to be redelivered. As a result, the delivery support device 40 can make the customer C who needs to redeliver recognize how much the environmental load increases by performing redelivery. Therefore, the delivery support device 40 can give the customer C the consciousness of not using the redelivery as much as possible.
(2) The delivery support device 40 can notify the customer C of the reference carbon dioxide emission QDB and the additional emission QDA by distinguishing them from each other. As a result, the amount of increase in the environmental load caused by the redelivery can be calculated with higher accuracy.
(3) The delivery support device 40 can give a penalty X corresponding to the additional emission QDA to the customers C who need redelivery. As a result, the delivery support device 40 can more strongly give the customer C an awareness of not using the redelivery as much as possible.

### Example of Change

The above-described embodiment can be modified as follows. The above-described embodiments and the following modifications can be implemented in combination with each other as long as they are not technically contradictory.

The delivery support device 40 may give a penalty other than a fine to the customer C who needs to be redelivered. Other penalties may include, for example, penalty points. In this case, the customer C whose total penalty point exceeds the threshold may not be redelivered for a certain period of time.

The delivery support device 40 may not penalize the customer C who wishes redelivery. In this case, the delivery support device 40 may not calculate the penalty. The delivery support device 40 may notify the customer C that needs to be redelivered of the sum of the reference carbon dioxide emission QDB and the additional emission QDA.

The control device 42 may calculate the reference carbon dioxide emission QDB and the additional emission QDA using other calculation methods that differ from the improved ton-kilometer method. Other calculation methods include, for example, the fuel method, the fuel economy method, and the ton-kilometer method (conventional ton-kilometer method).

The delivery support device 40 may calculate a parameter other than the emission amount of carbon dioxide as the magnitude of the environmental load associated with the redelivery, and notify the customer C of the parameter. For example, the delivery support device 40 may calculate the consumption amount of energy of the shipping vehicle 10 by traveling for redelivery, and notify the customer C of the consumption amount.

The control device 42 includes a CPU and a ROM, and is not limited to a device that executes a software-process. That is, the control device 42 may have any of the following configurations (a), (b), and (c).
(a) The control device 42 includes one or more processors that execute various processes in accordance with a computer program. The processor includes CPU and memories such as RAM and ROM. The memory stores program code or instructions configured to cause CPU to execute the process. Memory, or computer readable media, includes any available media that can be accessed by a general purpose or special purpose computer.
(b) The control device 42 includes one or more dedicated hardware circuits for executing various processes. Dedicated hardware circuits may include, for example, application-specific integrated circuits, i.e., ASIC or FPGA. Note that ASIC is an abbreviation of “Application Specific Integrated Circuit”, and FPGA is an abbreviation of “Field Programmable Gate Array”.
(c) The control device 42 includes a processor that executes a part of various kinds of processing in accordance with a computer program, and dedicated hardware circuits that execute the remaining processing among the various kinds of processing.

What is claimed is:

1. A delivery support device that notifies a customer that receives a delivery service of a package using a shipping vehicle, regarding a magnitude of environmental load associated with delivery of the package using the shipping vehicle, the delivery support device executing
calculating a magnitude of environmental load associated with redelivery of the package, when redelivery becomes necessary, and
notifying the customer needing redelivery regarding the magnitude of environmental load associated with the redelivery.

2. The delivery support device according to claim 1, wherein
a magnitude of a standard environmental load that is the environmental load when the package is delivered according to a predetermined shipping schedule is calculated, and
the magnitude of the standard environmental load, and the magnitude of environmental load associated with the redelivery, are distinguishably notified to the customer that needs the redelivery.

3. The delivery support device according to claim 1, wherein the customer needing redelivery is notified that a penalty corresponding to the magnitude of the environmental load associated with the redelivery will be imposed on the customer.

4. The delivery support device according to claim 1, wherein the magnitude of the environmental load is a carbon dioxide emission amount associated with traveling of the shipping vehicle, or an energy consumption amount of the shipping vehicle associated with traveling.
